(19) United States
(12) Patent Application Publication
(10) Pub. No.: US 2009/0244723 A1
(43) Pub. Date: Oct. 1, 2009

(54) Wide-Angle Lens

(75) Inventors: Takeshi KITAKATA, Kuwana-shi (JP); Takahiro SUGIYAMA, Saitama-ken (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/408,781

(22) Filed: Mar. 23, 2009

(30) Foreign Application Priority Data
Mar. 25, 2008 (JP) 2008-078207

(51) Int. Cl. G02B 9/12

(52) U.S. Cl. 359/784

(57) ABSTRACT

This invention is to enable a viewing angle of 110° or more with low chromatic aberration of magnification and distortion, while using a low number of lenses, such as 5 lenses. There is provided a first lens group and a second lens group arranged in order from a light incident side. The first lens group comprises a single negative lens, and a cemented lens that is a single positive lens and a single negative lens cemented together, and has negative power. The second lens group comprises two positive lenses and has positive power. The first lens group and the second lens group respectively include a single aspheric lens. Further, this wide-angle imaging lens satisfies the following conditional expression (1).

0.7≦|F₁/F₂|≦2.1 (1)

Where F1 is combined focal length of first lens group, and F2 is combined focal length of second lens group

### BACKGROUND OF THE INVENTION

1. Field of the Invention

The present invention relates to a wide-angle lens used in an imaging optical system.

2. Description of the Related Art

There have conventionally been proposed various types of lenses as an optical system for wide-angle imaging.

However, in a wide-angle lens with an imaging field of view of 110° or more, if it is attempted to improve the lens performance, the number of lenses used is increased, and it will become an expensive lens.

Also, in the patent publications below, there have been proposed comparatively inexpensive optical systems that have a large imaging field of view and a low number of lenses used. However, these optical systems have large chromatic aberration of magnification, and distortion, and as a result there is scope for improvement in lens performance.

[Patent Publication 1] Japanese patent publication 2002-023052
[Patent Publication 2] Japanese patent publication 2003-107344
[Patent publication 3] Japanese patent publication 2007-025261

### SUMMARY OF THE INVENTION

The present invention has been conceived in view of this type of situation. An object of the present invention is to provide a wide-angle imaging lens that has a lens construction of fewer lens elements, such as 5 lenses, while having low chromatic aberration of magnification and low distortion and a viewing angle of 110° or more.

The wide-angle imaging lens disclosed in this invention is provided with a first lens group and second lens group arranged in order from the light incident side. The first lens group comprises a single negative lens, and a cemented lens that is a single positive lens and a single negative lens cemented together, and has negative power. The second lens group comprises two positive lenses and has positive power. The first lens group and the second lens group respectively include a single aspheric lens. Further, this wide-angle imaging lens satisfies the following conditional expression (1).

0.7≦|F₁/F₂|≦2.1 (1)

Where, F1 is combined focal length of the first lens group, and F2 is combined focal length of the second lens group

In the wide-angle imaging lens, the following conditional expression (2) can be also satisfied.

0.8≦R₅/F≦1.6 (2)

where, R₅ is radius of curvature of a rear surface of a third lens group, and F is combined focal length of the entire lens system

In the wide-angle imaging lens, the following conditional expression (3) can be also satisfied.

30≦|ν₂−ν₃| (3)

Where, ν₂ is Abbe constant of a second lens, and ν₃ is Abbe constant of a third lens

The imaging device disclosed in claim 4 is provided with the wide-angle lens disclosed in any one of claims 1 to 3 as an imaging lens.

The above-described conditional expressions will be described in the following.

Conditional expression (1) is in order to obtain a wide-angle imaging lens with a viewing angle of 110° or more, and in order to make the lens system a retrofocus type and obtain a required back focus.

When |F₁/F₂| for conditional expression (1) is a magnitude in excess of an upper limit 2.1, the combined focal length of the first lens group becomes too long, and in order to obtain a viewing angle of 110° or more for a retrofocus lens the overall lens system becomes extremely large, and as a result the commercial value is significantly reduced.

Also, when |F₁/F₂| is smaller than a lower limit of 0.7, it is advantageous in obtaining a viewing angle of 110° or more, but is not preferable because the combined focal length of the first lens group will be too short, and the amount of positive spherical aberration and comatic aberration occurring in the first lens group will be too large.

According to the invention disclosed herein, it is possible to provide a wide-angle lens capable of having a viewing angle of 110° or more.

The conditional expression (2) is for compensating distortion to an appropriate amount.

When R₅/F is smaller than a lower limit 0.8, an amount of positive distortion arising with R₅ becomes too small, and it is not possible to appropriately compensate negative distortion arising with the retrofocus lens.

Also, if F₅/F is larger than an upper limit 1.6 it is advantageous in correcting distortion, but it is not preferred as the occurrence of negative spherical aberration and comatic aberration is too large.

According to the invention disclosed herein, it is possible to make negative distortion that is likely to arise in a retrofocus lens, an appropriate distortion.

Conditional expression (3) is for making correction of chromatic aberration of magnification appropriate.

When |ν₂−ν₃| is smaller than a lower limit 30, it is not-preferred because the effect of chromatic compensation of the second lens and the third lens is too small, and as a result correction of chromatic aberration of magnification becomes difficult.

According to the invention disclosed herein, it is possible to provide a lens where the occurrence of chromatic aberration of magnification is low.

### BRIEF DESCRIPTION OF THE DRAWINGS

FIG. 1 is a lens configuration drawing of working example 1 of a wide-angle imaging lens of the present invention.

FIG. 2 is various aberration diagrams of working example 1 of a wide-angle imaging lens of the present invention.

FIG. 3 is a lens configuration drawing of working example 2 of a wide-angle imaging lens of the present invention.

FIG. 4 is various aberration diagrams of working example 2 of a wide-angle imaging lens of the present invention.

FIG. 5 is a lens configuration drawing of working example 3 of a wide-angle imaging lens of the present invention.

FIG. 6 is various aberration diagrams of working example 3 of a wide-angle imaging lens of the present invention.

### DESCRIPTION OF PREFERRED EMBODIMENTS

Embodiments of a wide-angle imaging lens of the present invention will be described based on working examples 1 to 3.

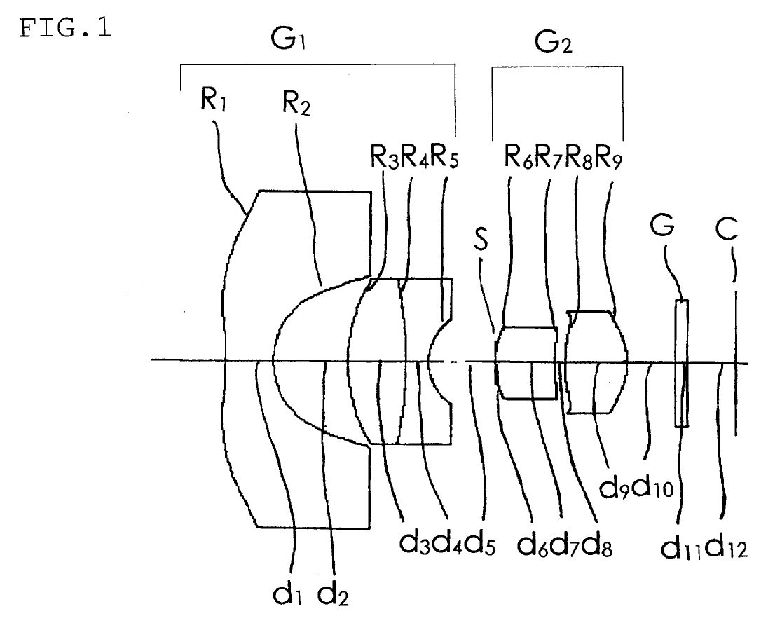

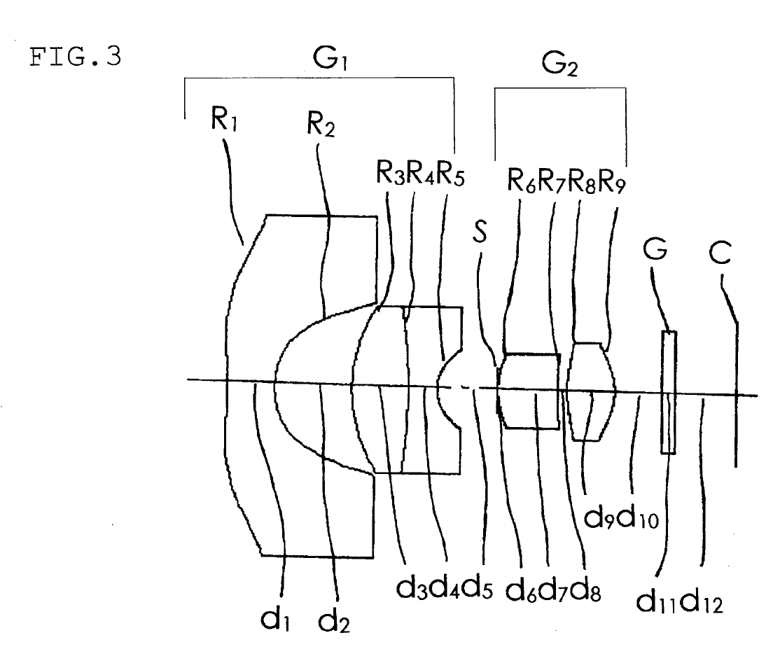

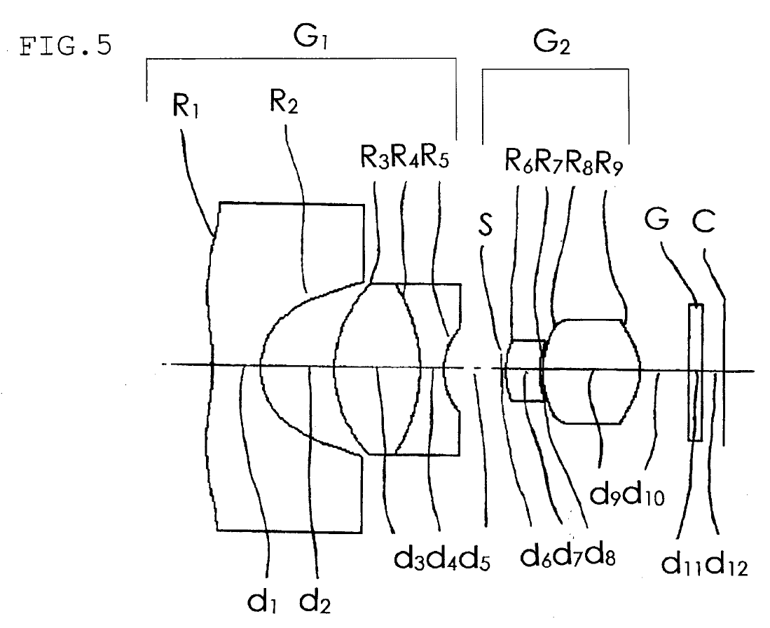

First, the lens configurations of working examples 1 to 3 are shown in FIG. 1, FIG. 3 and FIG. 5, respectively.

In the following, initially the lens configuration that is common to these working example will be described, and after that numerical examples for each working example will be described. The wide-angle imaging lens of each working example is constructed with a first lens group G1 and a second lens group G2 arranged in order from the light incident side.

The first lens group G1 is made up of a single negative lens (R1-R2), and a cemented lens having a single positive lens (R3-R4) and a single negative lens (R4-R5) cemented together, in order from the light incident side. Also, this first lens group G1 has a negative power.

The second lens group G2 is made up of two positive lenses (R6-R9) in order from the light incident side, and has a positive power.

As will be understood from the above, the imaging lens of this embodiment has a so-called retrofocus lens structure.

Further, the first lens group G1 and the second lens group G2 respectively include a single aspheric lens.

Also, in the structural diagrams for each lens (FIG. 1, FIG. 3 and FIG. 5), reference numeral G is insertion glass, C is a image sensor surface, and S is a diaphragm. The wide-angle imaging lens of each working example can be used as an imaging lens for an imaging device comprising an image sensor (for example, CCD or CMOS), or light sensitive film. The insertion glass is one example of an optical film or the like inserted for the purpose of preventing components that are troublesome (causing degradation in image quality) being incident on an image sensor, and is for cutting infra-red light and eliminating high resolution components beyond a specified resolution.

### Working Example 1

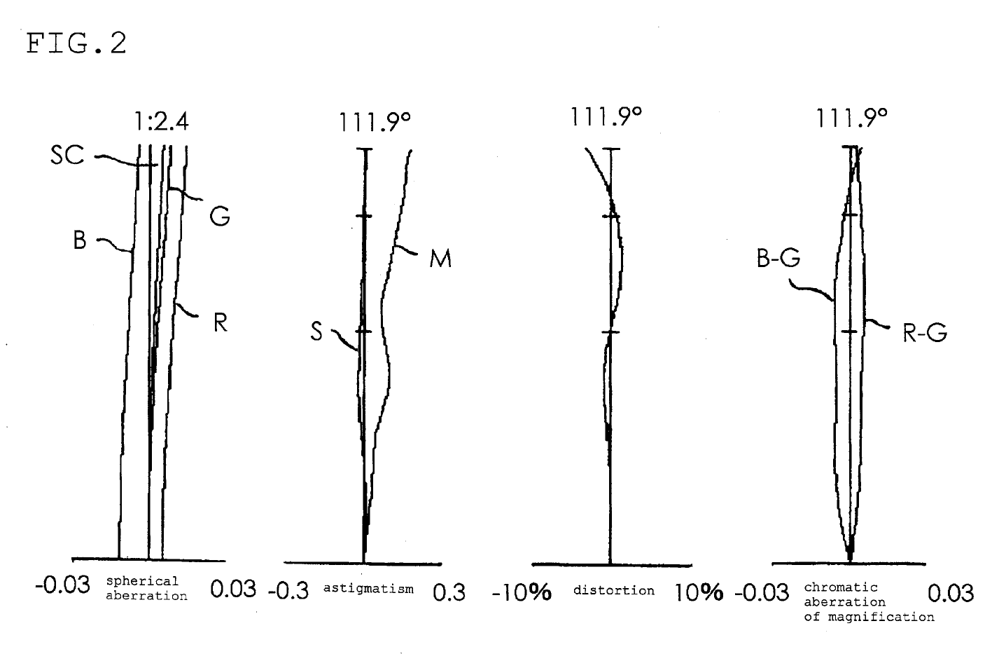

Various aberration diagrams for the lens configuration of working example 1 (FIG. 1) are shown in FIG. 2.

In the aberration diagrams of FIG. 2, reference numerals G, B and R written on spherical aberration and chromatic aberration of magnification respectively represent characteristics for wavelengths of green, blue and red. Also, reference numeral SC represents sine condition. Reference numeral S on astigmatism represents sagittal and M represents meridional.

Design values and obtained characteristics for working example 1 are shown in table 1. The meaning of entries in table 1 is as follows. Numerals in the left column of table 1 represent an order from the light incident side.

F: combined focal length of entire lens system

F1: combined focal length of first lens group

FB: back focus of entire lens system

R: radius of curvature

d: lens center thickness or air clearance

Nd: refractive index of d line (588 nm)

νd: Abbe constant of d line

R₅: radius of curvature of rear surface of a third lens

ν2: Abbe constant of second lens group

ν₃: Abbe constant of third lens group

Also, an aspherical surface equation is represented by the following equation.

x=cy²/(I+{square root over (1−(K+1)·c²y²))}+A₄y⁴+A₆y⁶+A₈y⁸+A₁₀y¹⁰

The meaning of symbols in this equation is as follows.

x: optical axis direction displacement from lens apex

c: curvature

y: height from optical axis

K: conic constant

A₄, A₆, A₈, A₁₀: coefficients for respective sub-scripted degrees

The meanings of each of the reference numerals in this working example are basically common to each of the working examples described later.

TABLE 1

| | R | d | Nd | Vd |
|---|---|---|---|---|
| 1 | −16.949 | 2.000 | 1.52998 | 55.80 |
| 2 | 5.317 | 3.155 | | |
| 3 | 9.708 | 2.443 | 1.84666 | 23.78 |
| 4 | −25.888 | 1.000 | 1.48749 | 70.44 |
| 5 | 3.000 | 2.857 | | |
| 6 | ∞ | .000 | | |
| | (diaphragm) | | | |
| 7 | 5.006 | 2.568 | 1.71300 | 53.94 |
| 8 | 22.555 | .403 | | |
| 9 | 8.052 | 2.614 | 1.52998 | 55.80 |
| 10 | −3.661 | 2.000 | | |
| 11 | ∞ | .550 | 1.51633 | 64.15 |
| 12 | ∞ | 2.008 | | |
| 13 | ∞ | | | |

| | |
|---|---|
| | Second |
| First surface aspherical | surface aspherical |
| surface coefficient | surface coefficient |

first lens aspherical surface coefficient

| | | |
|---|---|---|
| K | 0.0 | 0.0 |
| A4 | 0.18707857E−02 | 0.58089395E−03 |
| A6 | −0.27197593E−04 | 0.21730951E−03 |
| A8 | 0.18943562E−06 | 0.82845614E−05 |
| A10 | −0.54995737E−09 | −0.47802109E−06 |

fifth lens aspherical surface coefficient

| | | |
|---|---|---|
| K | 0.0 | 0.0 |
| A4 | −0.56592056E−02 | 0.69911375E−02 |
| A6 | 0.55433461E−03 | −0.33289251E−03 |
| A8 | 0.18024828E−07 | 0.10553680E−03 |
| A10 | −0.14256469E−04 | −0.69735528E−05 |

| | |
|---|---|
| angle of view | 111.9° |
| aperture ratio | 1:2.4 |
| F | 2.512 |
| FB | 4.371 |
| F1 | −4.453 |
| F2 | 4.295 |
| R5 | 3.000 |
| v2 | 23.78 |
| V3 | 70.44 |
| F1/F2 | −1.037 |
| R5/F | 1.195 |
| v2 − v3 | −46.56 |

As will be understood from the lens characteristics in table 1, the lens of this working example satisfies the conditional expressions (1) to (3) of the present invention.

### Working Example 2

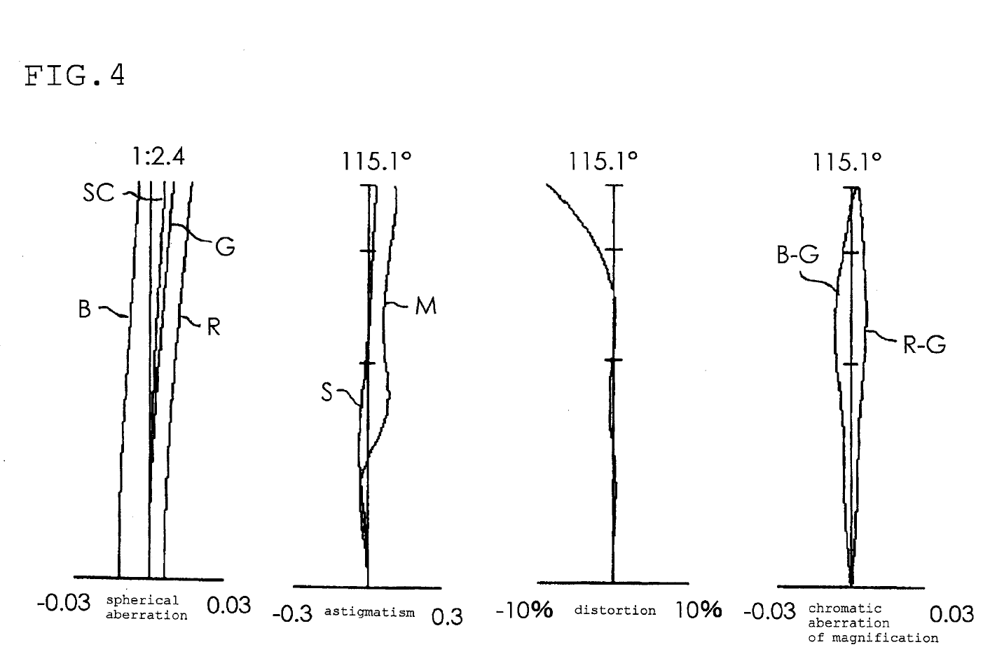

Various aberration diagrams for the lens configuration of working example 2 (FIG. 3) are shown in FIG. 4.

Design values and obtained characteristics for the lens of working example 2 are shown in the following.

TABLE 2

| | R | d | Nd | Vd |
|---|---|---|---|---|
| 1 | −21.264 | 2.000 | 1.52998 | 55.80 |
| 2 | 4.946 | 3.304 | | |
| 3 | 9.449 | 2.391 | 1.84666 | 23.78 |
| 4 | −32.654 | 1.240 | 1.48749 | 70.44 |
| 5 | 2.533 | 2.593 | | |
| 6 | ∞ | .000 | | |
| | (diaphragm) | | | |
| 7 | 5.032 | 2.518 | 1.71300 | 53.94 |
| 8 | 23.304 | .406 | | |
| 9 | 8.205 | 1.961 | 1.52998 | 55.80 |
| 10 | −3.688 | 2.000 | | |
| 11 | ∞ | .550 | 1.51633 | 64.15 |
| 12 | ∞ | 2.613 | | |
| 13 | ∞ | | | |

| | |
|---|---|
| | Second |
| First surface aspherical | surface aspherical |
| surface coefficient | surface coefficient |

first lens aspherical surface coefficient

| | | |
|---|---|---|
| K | 0.0 | 0.0 |
| A4 | 0.18449645E−02 | 0.20298529E−03 |
| A6 | −0.27962849E−04 | 0.28453436E−03 |
| A8 | 0.189653852E−06 | 0.61846846E−05 |
| A10 | −0.50501273E−09 | −0.56774051E−06 |

fifth lens aspherical surface coefficient

| | | |
|---|---|---|
| K | 0.0 | 0.0 |
| A4 | −0.40485950E−02 | 0.68731328E−02 |
| A6 | 0.76606895E−03 | −0.13048479E−03 |
| A8 | 0.79826071E−04 | 0.12730833E−03 |
| A10 | −0.27038187E−05 | −0.10353031E−04 |

| | |
|---|---|
| angle of view | 115.1° |
| aperture ratio | 1:2.4 |
| F | 2.512 |
| FB | 4.976 |
| F1 | −3.708 |
| F2 | 4.119 |
| R5 | 2.534 |
| v2 | 23.78 |
| V3 | 70.44 |
| F1/F2 | −0.900 |
| R5/F | 1.009 |
| v2 − v3 | −46.66 |

As will be understood from the lens characteristics in table 2, the lens of this working example satisfies the conditional expressions (1) to (3) of the present invention.

### Working Example 3

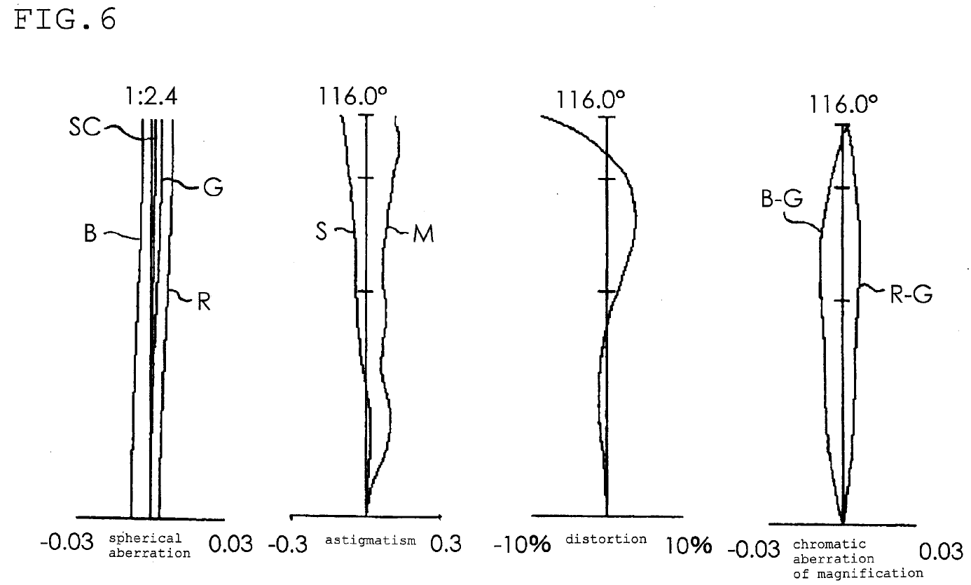

Various aberration diagrams for the lens configuration of working example 3 (FIG. 5) are shown in FIG. 6.

Design values and obtained characteristics for the lens of working example 3 are shown in the following.

TABLE 3

| | R | d | Nd | Vd |
|---|---|---|---|---|
| 1 | −12.668 | 2.000 | 1.52998 | 55.80 |
| 2 | 4.604 | 3.051 | | |
| 3 | 7.324 | 3.489 | 1.83400 | 37.34 |
| 4 | −9.423 | 1.000 | 1.48749 | 70.44 |
| 5 | 3.767 | 2.358 | | |
| 6 | ∞ | .000 | | |
| | (diaphragm) | | | |
| 7 | 4.876 | 1.438 | 1.77250 | 49.62 |
| 8 | 5.723 | .111 | | |
| 9 | 4.652 | 4.000 | 1.58913 | 61.25 |
| 10 | −3.072 | 2.000 | | |
| 11 | ∞ | .550 | 1.51633 | 64.15 |
| 12 | ∞ | .868 | | |
| 13 | ∞ | | | |

| | |
|---|---|
| | Second |
| First surface aspherical | surface aspherical |
| surface coefficient | surface coefficient |

first lens aspherical surface coefficient

| | | |
|---|---|---|
| K | 0.0 | 0.0 |
| A4 | 0.19879640E−02 | 0.21193200E−02 |
| A6 | −0.31983099E−04 | −0.18428521E−03 |
| A8 | 0.25927068E−06 | 0.46038019E−04 |
| A10 | −0.98409526E−09 | −0.18288236E−05 |

fifth lens aspherical surface coefficient

| | | |
|---|---|---|
| K | 0.0 | 0.0 |
| A4 | −0.10079558E−01 | 0.10418519E−01 |
| A6 | 0.41588268E−02 | 0.17188841E−03 |
| A8 | −0.12208625E−02 | 0.27382683E−04 |
| A10 | 0.12841120E−03 | 0.22156271E−05 |

| | |
|---|---|
| angle of view | 116.0° |
| aperture ratio | 1:2.4 |
| F | 2.512 |
| FB | 3.230 |
| F1 | −8.254 |
| F2 | 4.085 |
| R5 | 3.768 |
| v2 | 37.34 |
| V3 | 70.44 |
| F1/F2 | −2.021 |
| R5/F | 1.500 |
| v2 − v3 | −33.10 |

As will be understood from the lens characteristics in table 3, the lens of this working example satisfies the conditional expressions (1) to (3) of the present invention.

What is claimed is:

1. A wide-angle imaging lens comprising a first lens group and second lens group arranged in order from light incident side, wherein
the first lens group comprises a single negative lens, and a cemented lens that is a single positive lens and a single negative lens cemented together, and has negative power;
the second lens group comprises two positive lenses and has positive power; and
the first lens group and the second lens group respectively include a single aspheric lens, and wherein the following conditional expression (1) is satisfied:
0.7≦|F₁/F₂|≦2.1 (1)
where, F₁ is combined focal length of first lens group, and F₂ is combined focal length of second lens group.

2. The wide-angle lens of claim 1, wherein the following conditional expression (2) is satisfied:
0.8≦R₅/F≦1.6 (2)
where, R₅ is radius of curvature of a rear surface of a third lens, and F is combined focal length of the entire lens system.

3. The wide-angle lens of claim 1, wherein the following conditional expression (3) is satisfied:
30≦|ν₂−ν₃| (3)
where, ν₂ is the Abbe constant of the second lens, and ν₃ is the Abbe constant of the third lens.

4. The wide-angle lens of claim 2, wherein the following conditional expression (3) is satisfied:
30≦|ν₂−ν₃| (3)
where, ν₂ is the Abbe constant of the second lens, and ν₃ is the Abbe constant of the third lens.

5. An imaging device provided with the wide-angle lens of claim 1 as an imaging lens.

6. An imaging device provided with the wide-angle lens of claim 2 as an imaging lens.

7. An imaging device provided with the wide-angle lens of claim 3 as an imaging lens.

8. An imaging device provided with the wide-angle lens of claim 4 as an imaging lens.
